(19) United States
(12) Patent Application Publication
(10) Pub. No.: US 2021/0398103 A1
(43) Pub. Date: Dec. 23, 2021

(54) SECURE MOBILE POINT OF DISTRIBUTION DEVICE WITH SMART INTERFACE INTERACTIVITY

(71) Applicant: BANK OF AMERICA CORPORATION, Charlotte, NC (US)

(72) Inventors: Joseph Benjamin Castinado, North Glenn, CO (US); Lee Barry Frantz, Souderton, PA (US); Lee Ann Proud, Ponte Vedra, FL (US); Ann Ta, Scottsdale, AZ (US)

(73) Assignee: BANK OF AMERICA CORPORATION, Charlotte, NC (US)

(21) Appl. No.: 16/905,414

(22) Filed: Jun. 18, 2020

(51) Int. Cl. G06Q 20/32

(52) U.S. Cl. CPC G06Q 20/3227; G06Q 20/3278; G06Q 20/3224

(57) ABSTRACT

Embodiments of the invention are directed to a system, method, or computer program product for a secure mobile resource interaction device for mobile resource distribution services providing a smart interface interactivity linkage between parties. The system incorporates misappropriation service identifications for a merchant, a co-geolocation colocation, and a pinning element incorporated within the secure mobile resource interaction device to confirm security for completion of resource distribution. Upon qualification of one or more of the incorporated elements, the device may activate and provide a display for completion of resource distribution.

### BACKGROUND

For typical mobile resource interactions, an application on a mobile device may be used to complete resource distributions. However, these mobile devices are not architecturally designed for resource processing, as such access to and potential misappropriation of the device is possible. As such, a need exists for a secure mobile resource interaction device that includes smart interface interactivity for limiting potential misappropriation at the mobile interaction site.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

In some embodiments, the invention provides a secure mobile resource interaction device with smart interface interactivity linkage between parties. The system incorporates misappropriation service identifications for a merchant, a co-geolocation colocation, and a pinning element incorporated within the secure mobile resource interaction device to confirm security for completion of resource distribution. Upon qualification of one or more of the incorporated elements, the device may activate and provide a display for completion of resource distribution.

The secure mobile resource interaction device includes hardware and software to communicate for misappropriation detection. Furthermore, the secure mobile resource interaction device is linked directly to a user device associated with a merchant via a wireless network. The user device may be a merchant associate's mobile device, a vehicle, or the like. With this linkage, the secure mobile resource interaction device may only be operable based on satisfaction of security elements such as the secure mobile resource interaction device being within a specific distance from the user device or the secure mobile resource interaction device being at a pinned location. In this way, if a merchant is a mobile merchant at a tradeshow or a mobile merchant such as a food truck, if the secure mobile resource interaction device is outside the specified distance from the user device or not at the pinned location, the secure mobile resource interaction device will not be operational and will not allow for display of the merchant or customer information. The system may deactivate the secure mobile resource interaction device and provide an identification of the location of the secure mobile resource interaction device.

Embodiments of the present invention address these and/or other needs by providing an innovative system, method and computer program product for a secure mobile resource interaction device with smart interface interactivity, the invention comprising: identifying security elements associated with a user; embedding security elements within the secure mobile resource interaction device software for authorizing access to and operation of hardware of the secure mobile resource interaction device; linking the secure mobile resource interaction device to a user device associated with the user; identifying satisfaction of security element requirements for one or more of the security elements; activating the secure mobile resource interaction device based on the satisfaction of the security element requirements; allowing for user and customer interaction via the secure mobile resource interaction device; and shutting down the secure mobile resource interaction device upon identification of security element requirement modification.

In some embodiments, the invention further comprises not activating the secure mobile resource interaction device upon not reaching a threshold level of security element requirements.

In some embodiments, activating the secure mobile resource interaction device further comprises powering on the secure mobile resource interaction device and displaying a graphical user interface (GUI) to a customer for completion of a resource distribution to the user.

In some embodiments, the security elements comprise user history elements, wherein user history elements establish a class of products the user provides, a resource requirement range for the products, and locations associated with the user distribution of the products.

In some embodiments, the security elements comprise tracking a colocation of the user device and the secure mobile resource interaction device for identification of the secure mobile resource interaction device being within a predetermined distance from the user device.

In some embodiments, the security elements comprise a pinning element, wherein the pinning element allows activation and utilization of the mobile resource interaction device when the mobile resource interaction device is in a predetermined exact pinned location.

In some embodiments, linking the secure mobile resource interaction device to a user device associated with the user, further comprises generating a triangulation linkage between the user device, the secure mobile resource interaction device, and misappropriation servers comprising user history elements.

In some embodiments, the mobile resource interaction device performs functions of a point-of-transaction device to complete a transfer of resources from a customer to the user in exchange for products or services provided by the user to the customer.

In some embodiments, the user is a merchant providing goods or services at one or more mobile locations.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a secure mobile distribution system environment, in accordance with one embodiment of the present invention;

FIG. 2 provides a process for implementing the secure mobile distribution process, in accordance with one embodiment of the present invention;

FIG. 3 provides a system interaction process for implementation of the secure mobile distribution process, in accordance with one embodiment of the present invention; and

FIG. 4 provides a process flow illustrating completion of a resource distribution via the secure mobile distribution process, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

A “user” as used herein may refer to any merchant or merchant associate interacting with a customer. The user may interact with a customer, such as a customer purchasing a product or service from a merchant. Furthermore, as used herein the term “user device” or “mobile device” may refer to mobile phones, personal computing devices, tablet computers, wearable devices, and/or any portable electronic device capable of receiving and/or storing data therein.

As used herein, a “user interface” generally includes a plurality of interface devices and/or software that allow a customer to input commands and data to direct the processing device to execute instructions. For example, the user interface may include a graphical user interface (GUI) or an interface to input computer-executable instructions that direct the processing device to carry out specific functions. Input and output devices may include a display, mouse, keyboard, button, touchpad, touch screen, microphone, speaker, LED, light, joystick, switch, buzzer, bell, and/or other user input/output device for communicating with one or more users.

A “technology activity” may include a transaction for a product or service from a merchant. A “transaction” or “resource distribution” refers to any communication between a user and a customer to transfer funds for the purchasing or selling of a product or service. A transaction may refer to a purchase of goods or services, a return of goods or services, a payment transaction, a credit transaction, or other interaction involving an account. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

In various embodiments, the mobile distribution device may be a point-of-transaction device (POT) may be or include a merchant machine and/or server and/or may be or include the mobile device of the user may function as a point of transaction device. The embodiments described herein may refer to the use of a transaction, transaction event or point of transaction event to trigger the steps, functions, routines or the like described herein. In various embodiments, occurrence of a transaction triggers the sending of information such as alerts and the like. As used herein, a “bank account” refers to a credit account, a debit/deposit account, or the like. Although the phrase “bank account” includes the term “bank,” the account need not be maintained by a bank and may, instead, be maintained by other financial institutions. In some embodiments, a transaction may include one or more of the following: purchasing, renting, selling, and/or leasing goods and/or services (e.g., groceries, stamps, tickets, DVDs, vending machine items, or the like); withdrawing cash; making payments to creditors (e.g., paying monthly bills; paying federal, state, and/or local taxes and/or bills; or the like); sending remittances; transferring balances from one account to another account; loading money onto stored value cards (SVCs) and/or prepaid cards; donating to charities; and/or the like.

In some embodiments, the transaction may refer to a technology activity such as an event and/or action or group of actions facilitated or performed by a user's device, such as a user's mobile device. Such a device may be referred to herein as a “point-of-transaction device”. A “point-of-transaction” could refer to any location, virtual location or otherwise proximate occurrence of a transaction. A “point-of-transaction device” may refer to any device used to perform a transaction, either from the user's perspective, the merchant's perspective or both. In some embodiments, the point-of-transaction device refers only to a user's device, in other embodiments it refers only to a user device, and in yet other embodiments, it refers to both a customer device and a user device interacting to perform a transaction. For example, in one embodiment, the point-of-transaction device refers to the user's mobile device configured to communicate with a customer device, whereas in other embodiments, the point-of-transaction device refers to a terminal configured to communicate with a user's mobile device and customer's mobile device, and in yet other embodiments, the point-of-transaction device refers to both.

In some embodiments, a point-of-transaction device is or includes an interactive computer terminal that is configured to initiate, perform, complete, and/or facilitate one or more transactions. A point-of-transaction device could be or include any device that a user may use to perform a transaction with an entity, such as, but not limited to, an ATM, a loyalty device such as a rewards card, loyalty card or other loyalty device, a magnetic-based payment device (e.g., a credit card, debit card, or the like), a personal identification number (PIN) payment device, a contactless payment device (e.g., a key fob), a radio frequency identification device (RFID) and the like, a computer, (e.g., a personal computer, tablet computer, desktop computer, server, laptop, or the like), a mobile device (e.g., a smartphone, cellular phone, personal digital assistant (PDA) device, MP3 device, personal GPS device, or the like), a merchant terminal, a self-service machine (e.g., vending machine, self-checkout machine, or the like), a public and/or business kiosk (e.g., an Internet kiosk, ticketing kiosk, bill pay kiosk, or the like), a gaming device, and/or various combinations of the foregoing.

In some embodiments, a point-of-transaction device is operated in a public place (e.g., on a street corner, at the doorstep of a private residence, in an open market, at a public rest stop, or the like). In other embodiments, the point-of-transaction device is additionally or alternatively operated in a place of business (e.g., in a retail store, post office, banking center, grocery store, factory floor, or the like). In accordance with some embodiments, the point-of-transaction device is not owned by the user of the point-of-transaction device. Rather, in some embodiments, the point-of-transaction device is owned by a mobile business operator or a point-of-transaction operator (e.g., merchant, vendor, salesperson, or the like). In yet other embodiments, the point-of-transaction device is owned by the financial institution offering the point-of-transaction device providing functionality in accordance with embodiments of the invention described herein.

Further, the term “payment credential” or “payment vehicle,” as used herein, may refer to any of, but is not limited to refers to any of, but is not limited to, a physical, electronic (e.g., digital), or virtual transaction vehicle that can be used to transfer money, make a payment (for a service or good), withdraw money, redeem or use loyalty points, use or redeem coupons, gain access to physical or virtual resources, and similar or related transactions. For example, in some embodiments, the payment vehicle is a bank card issued by a bank which a customer may use to perform purchase transactions. However, in other embodiments, the payment vehicle is a virtual debit card housed in a mobile device of the customer, which can be used to electronically interact with an ATM or the like to perform financial transactions. Thus, it will be understood that the payment vehicle can be embodied as an apparatus (e.g., a physical card, a mobile device, or the like), or as a virtual transaction mechanism (e.g., a digital transaction device, digital wallet, a virtual display of a transaction device, or the like). The payment vehicle may be an unrestricted resource. Unrestricted resources, as used herein may be any resource that is not restricted for transaction. In this way, the unrestricted resources may be applied to any transaction for purchase of a product or service.

In some embodiments, the invention provides a secure mobile resource interaction device with smart interface interactivity linkage between parties. The system incorporates misappropriation service identifications for a merchant, a co-geolocation colocation, and a pinning element incorporated within the secure mobile resource interaction device to confirm security for completion of resource distribution. Upon qualification of one or more of the incorporated elements, the device may activate and provide a display for completion of resource distribution.

The secure mobile resource interaction device includes hardware and software to communicate for misappropriation detection. Furthermore, the secure mobile resource interaction device is linked directly to a user device associated with a merchant via a wireless network. The user device may be a merchant associate's mobile device, a vehicle, or the like. With this linkage, the secure mobile resource interaction device may only be operable based on satisfaction of security elements such as the secure mobile resource interaction device being within a specific distance from the user device or the secure mobile resource interaction device being at a pinned location. In this way, if a merchant is a mobile merchant at a tradeshow or a mobile merchant such as a food truck, if the secure mobile resource interaction device is outside the specified distance from the user device or not at the pinned location, the secure mobile resource interaction device will not be operational and will not allow for display of the merchant or customer information. The system may deactivate the secure mobile resource interaction device and provide an identification of the location of the secure mobile resource interaction device.

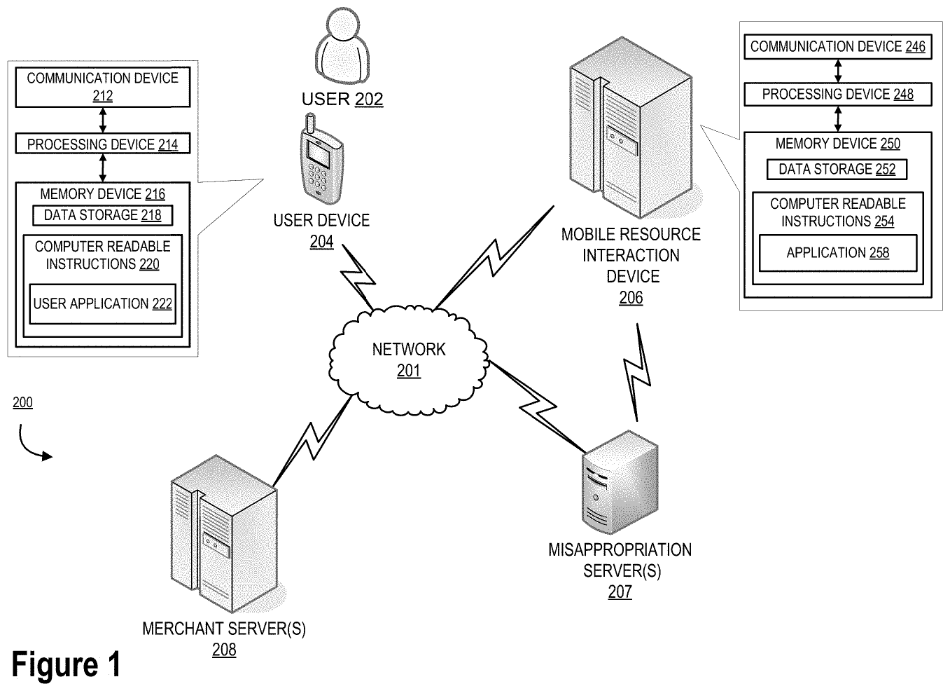

FIG. 1 provides a secure mobile distribution system environment 200, in accordance with one embodiment of the present invention. FIG. 1 provides the system environment 200 for which the distributive network system with specialized data feeds. FIG. 1 provides a unique system that includes specialized servers and system communicably linked across a distributive network of nodes required to perform the functions described herein.

As illustrated in FIG. 1, the merchant server 208 is operatively coupled, via a network 201 to the user device 204, misappropriation servers 207, and to the mobile resource interaction device 206. In this way, the merchant server 208 can send information to and receive information from the user device 204, misappropriation servers 207, and the mobile resource interaction device 206. FIG. 1 illustrates only one example of an embodiment of the system environment 200, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 is an individual or entity associated with a merchant that has one or more user devices 204. In some embodiments, the user 202 has a user device, such as a mobile phone, tablet, computer, or the like. FIG. 1 also illustrates a user device 204. The user device 204 may be, for example, a desktop personal computer, business computer, business system, business server, business network, a mobile system, such as a cellular phone, smart phone, personal data assistant (PDA), laptop, or the like. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the mobile resource interaction device 206, the merchant server 208, and the third party sever 207. As such, the communication device 212 generally comprises a modem, server, or other device for communicating with other devices on the network 201.

The user device 204 comprises computer-readable instructions 220 and data storage 218 stored in the memory device 216, which in one embodiment includes the computer-readable instructions 220 of a user application 222. In some embodiments, the user application 222 allows a user 202 to send and receive communications with the mobile resource interaction device 206.

As further illustrated in FIG. 1, the mobile resource interaction device 206 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the merchant server 208, the misappropriation server 207, the point-of-transaction device 205, and the user device 204. As such, the communication device 246 generally comprises a modem, server, or other device for communicating with other devices on the network 201.

As further illustrated in FIG. 1, the mobile resource interaction device 206 comprises computer-readable instructions 254 stored in the memory device 250, which in one embodiment includes the computer-readable instructions 254 of an application 258. In some embodiments, the memory device 250 includes data storage 252 for storing data related to the system environment 200, but not limited to data created and/or used by the application 258.

In one embodiment of the mobile resource interaction device 206 the memory device 250 stores an application 258. In one embodiment of the invention, the application 258 may associate with applications having computer-executable program code. Furthermore, the mobile resource interaction device 206, using the processing device 248 codes certain communication functions described herein. In one embodiment, the computer-executable program code of an application associated with the application 258 may also instruct the processing device 248 to perform certain logic, data processing, and data storing functions of the application. The processing device 248 is configured to use the communication device 246 to communicate with and ascertain data from one or more merchant server 208, misappropriation servers 207, and/or user device 204.

In some embodiments, the mobile resource interaction device 206 may be a POT device that includes an interactive computer terminal that is configured to initiate, perform, complete, and/or facilitate one or more transactions. The mobile resource interaction device 206 could be or include any device that a user or customer may use to perform a transaction with an entity, such as, but not limited to, an ATM, a loyalty device such as a rewards card, loyalty card or other loyalty device, a magnetic-based payment device (e.g., a credit card, debit card, etc.), a personal identification number (PIN) payment device, a contactless payment device (e.g., a key fob), a radio frequency identification device (RFID) and the like, a computer, (e.g., a personal computer, tablet computer, desktop computer, server, laptop, etc.), a mobile device (e.g., a smartphone, cellular phone, personal digital assistant (PDA) device, MP3 device, personal GPS device, or the like), a merchant terminal, a self-service machine (e.g., vending machine, self-checkout machine, or the like), a public and/or business kiosk (e.g., an Internet kiosk, ticketing kiosk, bill pay kiosk, or the like), a gaming device, and/or various combinations of the foregoing.

In some embodiments, the mobile resource interaction device 206 is operated in a public place (e.g., on a street corner, at the doorstep of a private residence, in an open market, at a public rest stop, and the like). In other embodiments, the mobile resource interaction device 206, is additionally or alternatively operated in a place of business (e.g., in a retail store, post office, banking center, grocery store, factory floor, and the like). In some embodiments, the mobile resource interaction device 206 is operated in a mobile place of business such as in a vehicle or at a tradeshow.

As illustrated in FIG. 1, the mobile resource interaction device 206 device may generally comprises a reading device, a communication device, a processing device, and a memory device. The reading device is operatively coupled to the processing device, communication device, and the memory device. The mobile resource interaction device 206 device may include a reader device to receive payment account information from the customer through the device, mobile application server, financial institution systems, and/or other potential payment devices.

Such a reader device may include, but is not limited to a magnetic strip reader, a barcode scanner, a radio frequency (RF) reader, a character recognition device, a magnetic ink reader, an NFC reading device, a processor for interpreting codes presented over an electrical or optical medium, a biometric reader, a wireless receiving device, and/or the like. In some embodiments, the reading device receives information that may be used to identify the customer's payment account from a payment device and may communicate via the communication device over a network, to other systems such as, but not limited to the mobile application server, financial institution systems, and/or the user device. As such, the communication device generally comprises a modem, server, or other device for communicating with other devices on the network 201.

In some embodiments, the mobile resource interaction device 206 is or includes an interactive computer terminal that is configured to initiate, perform, complete, and/or facilitate one or more transactions. The mobile resource interaction device 206 could be or include any means that a customer may use to perform a transaction with a user, such as, but not limited to, an ATM, a loyalty device such as a rewards card, loyalty card or other loyalty device, a magnetic-based payment device (e.g., a credit card, debit card, etc.), a personal identification number (PIN) payment device, a contactless payment device (e.g., a key fob), a radio frequency identification device (RFID) and the like, a computer, (e.g., a personal computer, tablet computer, desktop computer, server, laptop, or the like), a mobile device (e.g., a smartphone, cellular phone, personal digital assistant (PDA) device, MP3 device, personal GPS device, or the like), a merchant terminal, a self-service machine (e.g., vending machine, self-checkout machine, or the like), a public and/or business kiosk (e.g., an Internet kiosk, ticketing kiosk, bill pay kiosk, or the like), a gaming device, and/or various combinations of the foregoing.

In some embodiments, the mobile resource interaction device 206 is operated in a public place (e.g., on a street corner, at the doorstep of a private residence, in an open market, at a public rest stop, or the like). In other embodiments, the mobile resource interaction device 206 is additionally or alternatively operated in a place of business (e.g., in a retail store, post office, banking center, grocery store, factory floor, or the like).

The mobile resource interaction device 206 as discussed herein may include any point-of-transaction device mechanisms for completing a transaction. As such, the mobile resource interaction device 206 may be able perform a sale, an account balance check, a reward transfer, and account money transfer, a user opening up a bank application on his mobile device or computer, and/or the like.

In the embodiment illustrated in FIG. 1, an application allows the mobile resource interaction device 206 to be linked to the mobile application server and other devices on the network to communicate, via a network 201, the information related to the transaction being made, such as the transaction type, cost of transaction, product type, merchant location, and the like. In this way, the merchant module may provide confirmation authorization of a potential communication between the mobile resource interaction device 206 communicate a transaction with the user device either directly or indirectly, receive commands from a customer, receive a payment device for payment for a transaction, and provide storable transaction information. In one example, the customer enters into a transaction at a mobile resource interaction device 206 of a merchant, which processes the transaction. The merchant module may communicate the transaction, such as the products the customer is purchasing to the customer. In some embodiments, the merchant module may communicate the transaction to the mobile application server, which may, in turn provide the transaction communication to the user device and the customer device. In other embodiments, the merchant module may communicate the transaction to the mobile resource interaction device 206 GUI. In this way, the mobile resource interaction device 206 may display the products of the transaction, the price, and other aspects of the transaction either visually and/or audibly for the customer to review.

In some embodiment, the merchant module may provide confirmation of authorization of a potential communication between the customer and mobile resource interaction device 206. In this way, the customer may interact with the mobile resource interaction device 206 to ensure that the customer is wishing to enter into a transaction at the mobile resource interaction device 206. This interaction provides security functions, as well as initiating a transaction communication between the user system and the devices on the system 200.

The mobile resource interaction device 206 may receive an authorization request from a customer. The authorization request may include providing a PIN number input, touch connection, and/or unique code identification. In some embodiments, the authorization request may be a touch connection that may include a mat located at the mobile resource interaction device 206 such that the customer may place a device on the mat to authorize that the customer is wishing to transact with the merchant. In some embodiments, the authorization request may provide a unique code identification such as a NFC token, voice, text, and/or the like to authorize the communication. The authorization request may be a unique code identification presented to communicate that with the mobile resource interaction device 206. Unique code identifications may include, in some embodiments, various universal product codes (UPC codes), numbers associated with a UPC code, QR codes, and/or the like. In some embodiments, the UPC code may comprise a 12 digit code and include between a 6 to 10 digit company prefix. The authorization request may comprise UPC codes such as those assigned by the GS1 US (formerly the Uniform Code Council) and/or the like.

As illustrated in FIG. 1, the misappropriation server 207 is connected to the merchant server 208, user device 204, and mobile resource interaction device 206. The misappropriation server 207 has the same or similar components as described above with respect to the user device 204 and the mobile resource interaction device 206. While only one misappropriation server 207 is illustrated in FIG. 1, it is understood that multiple misappropriation servers 207 may make up the system environment 200. The misappropriation server 207 may be associated with one or more financial institutions, entities, or the like.

As illustrated in FIG. 1, the merchant server 208 is connected to the misappropriation server 207, user device 204, and mobile resource interaction device 206. The merchant server 208 may be associated with the mobile resource interaction device 206. The merchant server 208 has the same or similar components as described above with respect to the user device 204 and the mobile resource interaction device 206. While only one merchant server 208 is illustrated in FIG. 1, it is understood that multiple merchant server 208 may make up the system environment 200. It is understood that the servers, systems, and devices described herein illustrate one embodiment of the invention. It is further understood that one or more of the servers, systems, and devices can be combined in other embodiments and still function in the same or similar way as the embodiments described herein. The merchant server 208 may generally include a processing device communicably coupled to devices as a memory device, output devices, input devices, a network interface, a power source, one or more chips, and the like. The merchant server 208 may also include a memory device operatively coupled to the processing device. As used herein, memory may include any computer readable medium configured to store data, code, or other information. The memory device may include volatile memory, such as volatile Random Access Memory (RAM) including a cache area for the temporary storage of data. The memory device may also include non-volatile memory, which can be embedded and/or may be removable. The non-volatile memory may additionally or alternatively include an electrically erasable programmable read-only memory (EEPROM), flash memory or the like.

The memory device may store any of a number of applications or programs which comprise computer-executable instructions/code executed by the processing device to implement the functions of the merchant server 208 described herein.

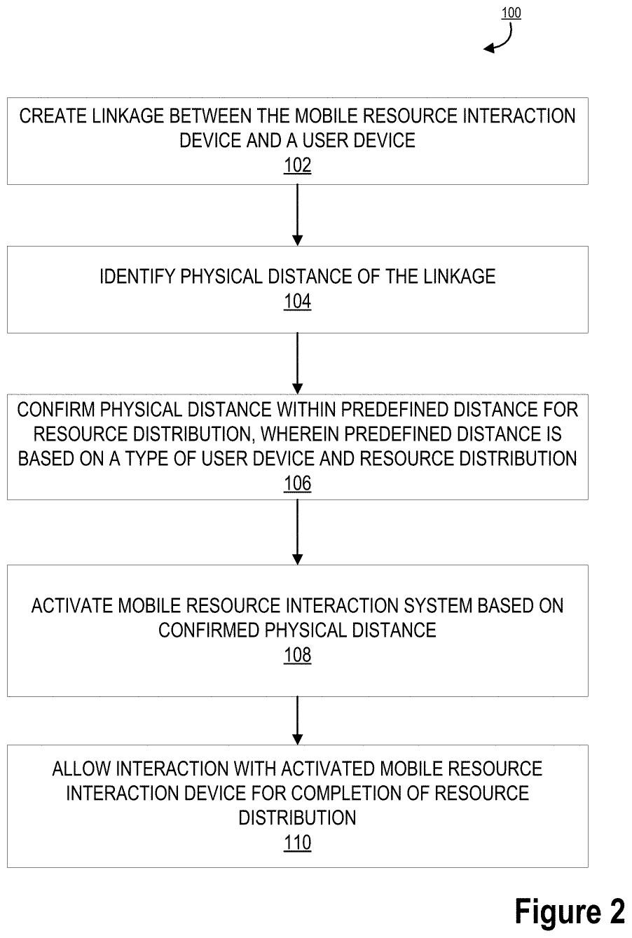

FIG. 2 provides a process for implementing the secure mobile distribution process 100, in accordance with one embodiment of the present invention. As illustrated in block 102, the process 100 is initiated by creating a linkage between the mobile resource interaction device and a user device. The mobile resource interaction device may be a mobile POT device with smart interface interactivity for secure mobile transactions for the merchant. A user device may be any device associated with a user that is an associate of the merchant and at the location of the mobile transaction.

Next, as illustrated in block 104, the process 100 continues by identifying the physical distance of the linkage. In this way, the system identifies the physical distance between the user device and the mobile resource interaction device. Once the distance is determined, the system may confirm if the distance is within a predefined distance for allowing resource distribution, wherein the predefined distance is based on a type of user device and a type of resource distribution, as illustrated in block 106.

For example, the user device may be a cellular telephone associated with a user. The user may be operating a mobile food truck. As such, in order for a transaction to occur and the mobile resource interaction device be operational, the system must identify the user device being within the truck and also the mobile resource interaction device with in the truck. At that point, the system confirms that there is no misappropriation with the mobile resource interaction device and that the transaction is that of the merchant and customer and not a third party.

Based on the identified co-localization of the mobile resource interaction device and the user device, the system may activate the mobile resource interaction device, as illustrated in block 108.

Once the mobile resource interaction device is activated, the customer and the user may be able to interact on the mobile resource interaction device as the POT device to complete the transaction for the product or service provided by the user. As illustrated in block 110, the process 100 is finalized by allowing the interaction with the mobile resource interaction device for completion of the resource distribution.

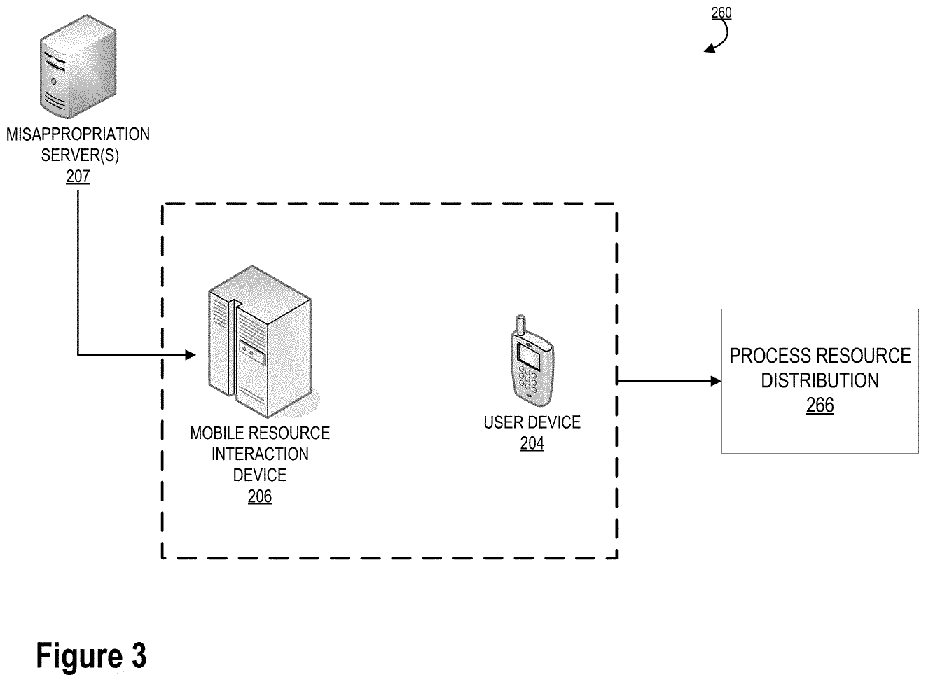

FIG. 3 provides a system interaction process for implementation of the secure mobile distribution process 260, in accordance with one embodiment of the present invention. As illustrated, the misappropriation servers 207 may provide the mobile resource interaction device 206 with information associated with the merchant based on the merchant being on-boarded to merchant services. In this way, the misappropriation servers 207 may pull information that the merchant provides about their business and examine their transaction history to establish a geo location for the merchant physical location and any mobile locations, identify the classes of products or services that the merchant offers, identify the locations of past customers that they have transacted with, and the like. This information is then used to place a fence around merchant transactions within the misappropriation servers 207, where if anything falls outside these parameters, the system provides a higher level of misappropriation analysis. The system is adaptive in that over time is follows the merchant's business and can adjust accordingly.

This information is provided to the mobile resource interaction device 206. The mobile resource interaction device 206 may also review other security elements, which includes the merchant history element, the linkage element, and the pinning element. The merchant history element is provided above by the misappropriation servers 207. The linkage element provides an identification of colocation of the user device 204 and the mobile resource interaction device 206 to confirm a location of the two devices within a predetermined physical location. Finally, the pinning element may include the mobile resource interaction device 206 identifying its location and ensuring that it is in the predetermined pinned location.

If these security elements are met, the mobile resource interaction device 206 may activate for user and customer activity and process the resource distribution, as illustrated in block 266

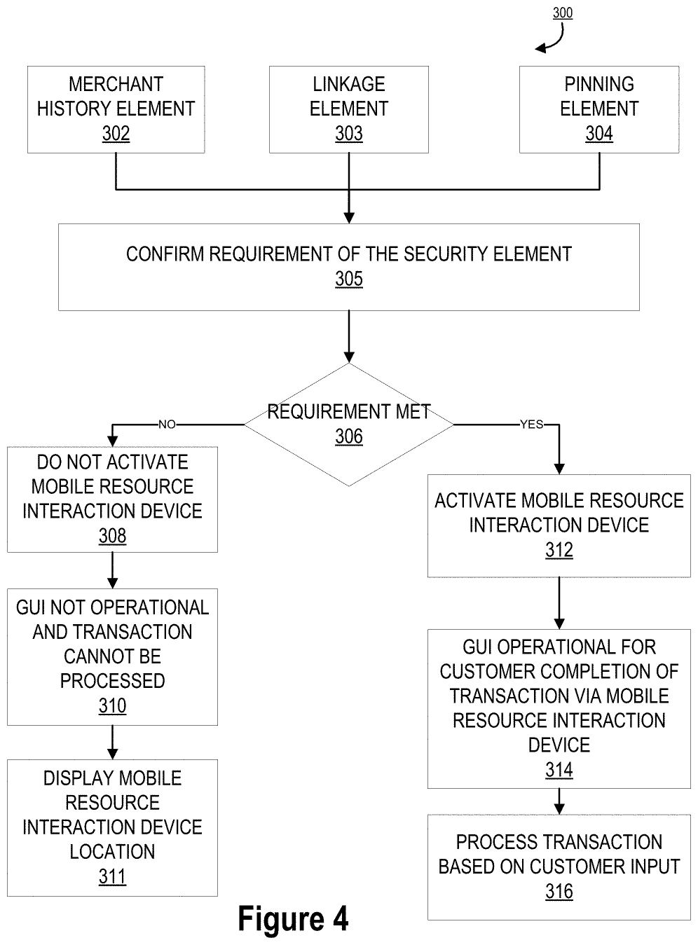

FIG. 4 provides a process flow illustrating completion of a resource distribution via the secure mobile distribution process 300, in accordance with one embodiment of the present invention. As illustrated, the process 300 is initiated by reviewing the one or more security elements. The security elements may include one or more of the merchant history element 302, the linkage element 303, or the pinning element 304.

In some embodiments, the merchant history element 302 establish class of products/services associated with the merchant and establishes locations associated with the merchant. As such, when a transaction is generated and being processed by the mobile resource interaction device, the system may confirm that it is at a location the user or merchant has been and that the transaction is for a product or service within the merchant's classification.

The linkage element 303 establishes a linkage between the mobile resource interaction device and a user device associated with an associate of the merchant. In this way, the system may colocalize the user device and the mobile resource interaction device, so that if the devices are located within a predetermined distance, the system may allow the mobile resource interaction device to activate and allow for completion of the transaction using the mobile resource interaction device.

The pinning element 304 establishes a pinned point or pinned location that requires the mobile resource interaction device to be located at that specific pinned point in order to be activated. The pinned point may be on a vehicle or on a specific table or the like. The vehicle or table may move, but as long as the mobile resource interaction device is placed on the pinned point, the mobile resource interaction device may be activated for completion of a transaction.

As illustrated in block 305, the process 300 continues by confirming the requirements of the security elements. In this way, the user may select one or more security elements for monitoring and reviewing. The system may monitor the selected one or more security elements and identify if the requirement was met, as illustrated in block 306.

If the requirement was not met, the system does not activate the mobile resource interaction device, as illustrated in block 308, which effectively does not allow the transaction to process between the customer and the user. As such, the GUI on the mobile resource interaction device is not operational, preventing the customer from transacting with the merchant and preventing the transaction from being processed, as illustrated in block 310.

Finally, as illustrated in block 311, the process 300 continues by displaying to the user, the location of the mobile resource interaction device, as it may have been misappropriated based on not satisfying the security element requirement.

If the requirement is met in block 306, the process 300 continues by activating the mobile resource interaction device, as illustrated in block 312. In this way, once the mobile resource interaction device is activated the GUI is operational for customer completion of the transaction via the GUI on the mobile resource interaction device, as illustrated in block 314. Finally, as illustrated in block 316, the process 300 is finalized by processing the transaction based on customer input of a payment credential on the mobile resource interaction device.

In some embodiments, the invention provides a secure mobile resource interaction device with smart interface interactivity linkage between parties. The system incorporates misappropriation service identifications for a merchant, a geolocation colocation, and a pinning element incorporated within the secure mobile resource interaction device to confirm security for completion of resource distribution. Upon qualification of one or more of the incorporated elements, the device may activate and provide a display for completion of resource distribution.

The secure mobile resource interaction device includes hardware and software to communicate for misappropriation detection. Furthermore, the secure mobile resource interaction device is linked directly to a user device associated with a merchant via a wireless network. The user device may be a merchant associate's mobile device, a vehicle, or the like. With this linkage, the secure mobile resource interaction device may only be operable based on satisfaction of security elements such as the secure mobile resource interaction device being within a specific distance from the user device or the secure mobile resource interaction device being at a pinned location. In this way, if a merchant is a mobile merchant at a tradeshow or a mobile merchant such as a food truck, if the secure mobile resource interaction device is outside the specified distance from the user device or not at the pinned location, the secure mobile resource interaction device will not be operational and will not allow for display of the merchant or customer information. The system may deactivate the secure mobile resource interaction device and provide an identification of the location of the secure mobile resource interaction device.

As such, a mobile resource interaction device is generated with the following security elements including a merchant history security element, a linkage element, and a pinning element. The merchant history element establish class of products/services associated with the merchant and establishes locations associated with the merchant. As such, when a transaction is generated and being processed by the mobile resource interaction device, the system may confirm that it is at a location the user or merchant has been and that the transaction is for a product or service within the merchant's classification.

The linkage element establishes a linkage between the mobile resource interaction device and a user device associated with an associate of the merchant. In this way, the system may colocalize the user device and the mobile resource interaction device, so that if the devices are located within a predetermined distance, the system may allow the mobile resource interaction device to activate and allow for completion of the transaction using the mobile resource interaction device.

The pinning element establishes a pinned point or pinned location that requires the mobile resource interaction device to be located at that specific pinned point in order to be activated. The pinned point may be on a vehicle or on a specific table or the like. The vehicle or table may move, but as long as the mobile resource interaction device is placed on the pinned point, the mobile resource interaction device may be activated for completion of a transaction.

The user may be able to set one or more of the security elements for the transaction period for the merchant. Upon identification of a customer transaction interaction, the system may confirm the security elements selected are satisfied. The system may then activated the mobile resource interaction device for the merchant and customer to complete the transaction using the GUI associated with the mobile resource interaction device.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for a secure mobile resource interaction device with smart interface interactivity, the system comprising:
a memory device with computer-readable program code stored thereon;
a communication device, wherein the communication device is configured to establish operative communication with a plurality of networked devices via a communication network;
a processing device operatively coupled to the memory device and the communication device, wherein the processing device is configured to execute the computer-readable program code to:
identify security elements associated with a user;
embed security elements within the secure mobile resource interaction device software for authorizing access to and operation of hardware of the secure mobile resource interaction device;
link the secure mobile resource interaction device to a user device associated with the user;
identify satisfaction of security element requirements for one or more of the security elements;
activate the secure mobile resource interaction device based on the satisfaction of the security element requirements;
allow for user and customer interaction via the secure mobile resource interaction device; and
shut down the secure mobile resource interaction device upon identification of security element requirement modification.

2. The system of claim 1, further comprising not activating the secure mobile resource interaction device upon not reaching a threshold level of security element requirements.

3. The system of claim 1, wherein activating the secure mobile resource interaction device further comprises powering on the secure mobile resource interaction device and displaying a graphical user interface (GUI) to a customer for completion of a resource distribution to the user.

4. The system of claim 1, wherein the security elements comprise user history elements, wherein user history elements establish a class of products the user provides, a resource requirement range for the products, and locations associated with the user distribution of the products.

5. The system of claim 1, wherein the security elements comprise tracking a colocation of the user device and the secure mobile resource interaction device for identification of the secure mobile resource interaction device being within a predetermined distance from the user device.

6. The system of claim 1, wherein the security elements comprise a pinning element, wherein the pinning element allows activation and utilization of the mobile resource interaction device when the mobile resource interaction device is in a predetermined exact pinned location.

7. The system of claim 1, wherein linking the secure mobile resource interaction device to a user device associated with the user, further comprises generating a triangulation linkage between the user device, the secure mobile resource interaction device, and misappropriation servers comprising user history elements.

8. The system of claim 1, wherein the mobile resource interaction device performs functions of a point-of-transaction device to complete a transfer of resources from a customer to the user in exchange for products or services provided by the user to the customer.

9. The system of claim 1, wherein the user is a merchant providing goods or services at one or more mobile locations.

10. A computer program product for a secure mobile resource interaction device with smart interface interactivity, the computer program product comprising at least one non-transitory computer-readable medium having computer-readable program code portions embodied therein, the computer-readable program code portions comprising:
an executable portion configured for identifying security elements associated with a user;
an executable portion configured for embedding security elements within the secure mobile resource interaction device software for authorizing access to and operation of hardware of the secure mobile resource interaction device;
an executable portion configured for linking the secure mobile resource interaction device to a user device associated with the user;
an executable portion configured for identifying satisfaction of security element requirements for one or more of the security elements;
an executable portion configured for activating the secure mobile resource interaction device based on the satisfaction of the security element requirements;
an executable portion configured for allowing for user and customer interaction via the secure mobile resource interaction device; and
an executable portion configured for shutting down the secure mobile resource interaction device upon identification of security element requirement modification.

11. The computer program product of claim 10, further comprising an executable portion configured for not activating the secure mobile resource interaction device upon not reaching a threshold level of security element requirements.

12. The computer program product of claim 10, wherein activating the secure mobile resource interaction device further comprises powering on the secure mobile resource interaction device and displaying a graphical user interface (GUI) to a customer for completion of a resource distribution to the user.

13. The computer program product of claim 10, wherein the security elements comprise user history elements, wherein user history elements establish a class of products the user provides, a resource requirement range for the products, and locations associated with the user distribution of the products.

14. The computer program product of claim 10, wherein the security elements comprise tracking a colocation of the user device and the secure mobile resource interaction device for identification of the secure mobile resource interaction device being within a predetermined distance from the user device.

15. The computer program product of claim 10, wherein the security elements comprise a pinning element, wherein the pinning element allows activation and utilization of the mobile resource interaction device when the mobile resource interaction device is in a predetermined exact pinned location.

16. The computer program product of claim 10, wherein linking the secure mobile resource interaction device to a user device associated with the user, further comprises generating a triangulation linkage between the user device, the secure mobile resource interaction device, and misappropriation servers comprising user history elements.

17. A computer-implemented method for a secure mobile resource interaction device with smart interface interactivity, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
identifying security elements associated with a user;
embedding security elements within the secure mobile resource interaction device software for authorizing access to and operation of hardware of the secure mobile resource interaction device;
linking the secure mobile resource interaction device to a user device associated with the user;
identifying satisfaction of security element requirements for one or more of the security elements;
activating the secure mobile resource interaction device based on the satisfaction of the security element requirements;
allowing for user and customer interaction via the secure mobile resource interaction device; and
shutting down the secure mobile resource interaction device upon identification of security element requirement modification.

18. The computer-implemented method of claim 17, wherein activating the secure mobile resource interaction device further comprises powering on the secure mobile resource interaction device and displaying a graphical user interface (GUI) to a customer for completion of a resource distribution to the user.

19. The computer-implemented method of claim 17, wherein the security elements comprise a pinning element, wherein the pinning element allows activation and utilization of the mobile resource interaction device when the mobile resource interaction device is in a predetermined exact pinned location.

20. The computer-implemented method of claim 17, wherein linking the secure mobile resource interaction device to a user device associated with the user, further comprises generating a triangulation linkage between the user device, the secure mobile resource interaction device, and misappropriation servers comprising user history elements.
